(19) United States
(12) Patent Application Publication
(10) Pub. No.: US 2026/0194194 A1
(43) Pub. Date: Jul. 9, 2026

(54) LIGHT FIXTURE

(71) Applicant: Hunter Industries, Inc., San Marcos, CA (US)

(72) Inventor: Jesus Moreno-Perez, Chula Vista, CA (US)

(21) Appl. No.: 19/441,671

(22) Filed: Jan. 6, 2026

Related U.S. Application Data
(60) Provisional application No. 63/742,777, filed on Jan. 7, 2025.

(51) Int. Cl. F21S 8/02; F21V 14/02; F21V 17/12; F21V 23/00; F21W 131/10

(52) U.S. Cl. CPC F21S 8/022; F21V 14/02; F21V 17/12; F21V 23/005; F21W 2131/10

(57) ABSTRACT

A mount for use with an in-grade light assembly is disclosed. The mount is configured for installation by pouring a material around the mount after the mount is positioned at or below a planned ground level of the material. The mount can include a first end configured to be positioned at or below the planned ground level of the material, a second end opposite the first end, and a sleeve portion between the first end and the second end. The sleeve portion has one or more locking structures sized and shaped to extend into the material so as to inhibit at least rotation of the mount relative to the material.

### CROSS-REFERENCE TO RELATED APPLICATION

This application claims benefit under 35 U.S.C. 119(e) to U.S. Provisional Patent Application No. 63/742,777, filed Jan. 7, 2025, the entire disclosure of which is hereby incorporated by reference herein in its entirety. Any and all priority claims identified in the Application Data Sheet, or any corrections thereto, are hereby incorporated by reference under 37 CFR 1.57.

### BACKGROUND

### Technical Field

The present invention relates to light fixtures and assemblies, and more particularly, to light fixture mounts for placement in outdoor areas where concrete, dirt, clay, or other materials will be poured.

### Description of the Related Art

Outdoor lighting is popular for security, aesthetic, safety, and other reasons. Various types of commercial landscape light fixtures are available to meet the particular needs of residential or commercial properties. These include path, down, deck, tree, spot, spread, and security light fixtures.

### SUMMARY

In many installations and circumstances, it is desirable to install light fixtures in areas that may be subject to vehicle traffic. This can be especially true in installation environments which are subsequently covered in concrete, dirt, clay, or other materials. Light fixtures placed in such installations may be subject to not only weight of a vehicle but also rotational loading caused by a tire of the vehicle turning when in contact with the light fixture. Such loading can cause a typical outer housing to break free and rotate causing, for example, damage to the light fixture and/or degradation in performance (e.g., beam misalignment).

In certain embodiments, the light fixture is secured within an outer housing and a mount. The mount is placed around the outer housing and includes locking features (e.g., fins, gussets, etc.) which interact with the concrete, dirt, clay, or other materials to prevent, for example, rotation of the mount relative to the material even when experiencing loading caused in part by, for example, turning of the tire when on the light fixture.

The light fixture includes many or most of the lighting and/or electrical components of the light fixture. In some cases, an inner housing assembly of the light fixture is interchangeable with other inner housing assemblies (e.g., replacement inner housing assemblies having varying lighting/power/operable features). The inner housing assembly can include structure configured to facilitate easy installation and removal of the body from the outer housing.

An aspect is directed to an in-grade light assembly for installation in a surrounding material that comprises a mount having a first end configured to be positioned at or below a planned ground level of the surrounding material, a second end opposite the first end, and a sleeve portion between the first end and the second end. The sleeve portion can have one or more locking structures sized and shaped to direct flow of the surrounding material as the surrounding material is poured around the mount. The in-grade light assembly can further include an outer housing sized and shaped to fit within the mount and an inner housing assembly sized and shaped to fit at least partially within the mount and the outer housing.

A variation of the aspect above is, wherein the surrounding material is concrete.

A variation of the aspect above is, wherein the one or more locking structures is a fin.

A variation of the aspect above is, wherein the one or more locking structures is a gusset.

A variation of the aspect above is, wherein the one or more locking structures is a passage.

A variation of the aspect above is, wherein the one or more locking structures is a platform.

A variation of the aspect above is, wherein the one or more locking structures is a channel.

A variation of the aspect above is, wherein the one or more locking structures are configured to abut the surrounding material so as to inhibit at least rotation of the mount relative to the surrounding material.

A variation of the aspect above, further comprises one or more screws configured to secure the inner housing assembly to the mount.

A variation of the aspect above, further comprises a cover configured to prevent access to the one or more screws when the cover is secured to the inner housing assembly.

A variation of the aspect above is, wherein the inner housing assembly comprises a light module, the light module being configured to emit light through the first end of the mount when the inner housing assembly is installed within the mount.

A variation of the aspect above is, wherein the inner housing assembly comprises a lens assembly.

A variation of the aspect above is, wherein the lens assembly comprises at least one fastener aperture configured to align with at least one fastener aperture of the inner housing assembly.

An aspect is directed to an in-grade light assembly for installation in a surrounding material that comprises a mount having a first end configured to be positioned at or below a planned ground level of the surrounding material, a second end opposite the first end, and a sleeve portion between the first end and the second end. The sleeve portion can have one or more locking structures sized and shaped to direct flow of the surrounding material as the surrounding material is poured around the mount. The in-grade light assembly can further include an outer housing sized and shaped to fit within the mount and an installation cap configured to connect to the first end of the mount. The installation cap can include a cover portion configured to cover the first end of the mount and a wall connected to and extending from the cover portion in a direction away from the cover portion. The wall can be configured to connect a support to suspend the mount downward into an installation site.

An aspect is directed to a mount for use with an in-grade light assembly. The mount can be configured for installation by pouring a material around the mount after the mount is positioned at or below a planned ground level of the material and comprise a first end configured to be positioned at or below the planned ground level of the material, a second end opposite the first end, and a sleeve portion between the first end and the second end. The sleeve portion can have one or more locking structures sized and shaped to extend into the material so as to inhibit at least rotation of the mount relative to the material.

A variation of the aspect above is, wherein the mount has a hollow-shape.

A variation of the aspect above is, wherein the hollow-shape of the mount is sized to receive an outer housing.

A variation of the aspect above is, wherein the one or more locking structures is a fin.

A variation of the aspect above is, wherein the one or more locking structures is a gusset.

A variation of the aspect above is, wherein the one or more locking structures is a passage.

A variation of the aspect above is, wherein the one or more locking structures is a platform.

A variation of the aspect above is, wherein the one or more locking structures is a channel.

A variation of the aspect above is, wherein the material is concrete.

A variation of the aspect above is, wherein the material is dirt.

A variation of the aspect above is, wherein the material is clay.

A variation of the aspect above is, wherein the one or more locking structures are configured to abut the material so as to inhibit at least rotation of the mount relative to the material.

An aspect is directed to a method of assembling an in-grade light assembly that includes placing a mount on a surface that is below a planned ground level, the mount surrounding an outer housing and having one or more locking structures disposed on an outer surface of the mount, pouring a material on the surface near the mount so that the material flows between the one or more locking structures, and inserting an inner housing assembly into an open end of the mount.

A variation of the aspect above, further comprises securing the inner housing assembly to the mount.

A variation of the aspect above, further comprises securing a cover to the inner housing assembly.

A variation of the aspect above is, wherein the material is dirt.

A variation of the aspect above is, wherein the material is clay.

A variation of the aspect above is, wherein securing the inner housing assembly to the mount comprises engaging one or more teeth with one or more holes or recesses.

A variation of the aspect above further comprises a ring, wherein the one or more teeth are disposed on the mount and the one or more holes or recesses are disposed on the ring.

An aspect is directed to an in-grade light assembly for installation in a surrounding material. The in-grade light assembly can comprise a mount having a first end configured to be positioned at or below a planned ground level of the surrounding material, a second end opposite the first end, and a sleeve portion between the first end and the second end. The in-grade light assembly can further comprise an outer housing sized and shaped to fit within the mount, an inner housing assembly sized and shaped to fit at least partially within the mount and the outer housing, and a ring being disposed so as to contact at least a portion of the mount and prevent relative rotation of the inner housing assembly relative to the mount.

A variation of the aspect above is, wherein the portion of the mount comprises a first engagement structure, and wherein the ring comprises a second engagement structure, the second engagement structure contacting the first engagement structure to prevent the relative rotation of the inner housing assembly relative to the mount.

A variation of the aspect above is, wherein the first engagement structure is one or more teeth, and wherein the second engagement structure is one or more holes or recesses.

A variation of the aspect above further comprises one or more screws, wherein rotation of the one or more screws causes the one or more teeth to engage with the one or more holes or recesses.

### BRIEF DESCRIPTION OF THE DRAWINGS

The present disclosure is described with reference to the accompanying drawings, in which like reference characters reference like elements, and wherein:

FIG. 1 is a perspective, top, side view of an in-grade light assembly that includes a mount configured to be disposed almost entirely below ground level.

FIG. 2 is a side view of the light assembly from FIG. 1.

FIG. 3 is a cross-section view of the light assembly of FIG. 2 taken along the cut-plane B-B.

FIG. 4 is an exploded view of the light assembly from FIG. 1 showing how the mount is assembled to the outer housing.

FIG. 5 is a perspective view of the light assembly from FIG. 1 with the inner housing assembly temporarily replaced with an installation cap.

FIG. 6 is a side view of the light assembly and installation cap from FIG. 5.

FIG. 7 is a cross-section view of the light assembly of FIG. 6 taken along the cut-plane C-C.

FIG. 8 is an exploded view of the light assembly from FIG. 4 showing how the installation cap is assembled to the mount.

FIG. 9 is a partial view of the light assembly from FIG. 3 showing one or more teeth projecting in a downward direction from the mount for engagement with one or more holes or recesses in the ring so as to clamp the inner housing assembly to the mount.

### DETAILED DESCRIPTION

Outdoor light fixtures are often exposed to environmental hazards such as moisture, temperature variants, dirt, wind, sunlight, and other hazards. Additionally, like many electrical devices, light fixtures often require routine and non-routine maintenance for a variety of reasons. For example, light engines, light bulbs, circuits, wiring, and other components of light fixtures may have limited service lives and may require replacement and/or repair. In some cases, one or more components of the light fixture may be consumable, while all or most of the remaining components are designed for long-term installation and use.

Repair and replacement of components in a light fixture, especially an outdoor light fixture, can be costly, as the maintenance services can require specially-trained technicians and may require complete or substantially complete replacement of the entire fixture. As such, it is desirable that the repair of light fixtures be simplified to both reduce the cost of repair and to expedite the process of repairing fixtures.

In-ground lights are sometimes referred to as “in-grade lights”. In-Grade lights can provide desired lighting for applications such as landscaping, structural lighting, pathway lighting, or other applications where upward-directed light is desired. In-Grade lights can also be used in applications to provide downward-directed or sideways-directed light. In-Grade lights can be installed in many environments including, but not limited to, landscaping beds, concrete (e.g., walkways or driveways), and/or turf. In-Grade lights can have a low profile (e.g., extend very little or not at all in an upward direction from the ground). In-Grade lights can be flush with or (entirely or partially) recessed from an adjacent surface. In some applications, activities such as lawn mowing, walking, driving, pressure-washing, and/or other activities can be performed on and/or near in-grade lights without negatively impacting the integrity or performance of the light.

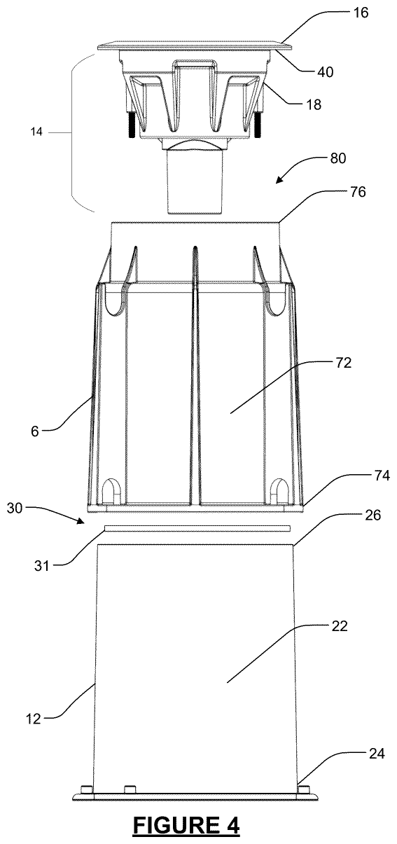

Embodiments of the in-grade light assembly 10 are secured within an outer housing 12 (see FIG. 4) and a mount 6. The mount 6 is placed around the outer housing 12 and includes locking features (e.g., fins, gussets, etc.) which interact with its surrounding (e.g., concrete, dirt, clay, or other materials) to prevent, for example, rotation of the mount 6 relative to the material even when experiencing loading caused in part by, for example, turning of a vehicle's tire when on the in-grade light assembly 10. In certain embodiments, the in-grade light assembly 10 includes a hollow shaped outer housing 12 which is fixedly installed almost entirely below ground level 8. In certain embodiments, a hollow-shaped mount 6 is installed outside the outer housing 12.

In certain embodiments, the mount 6 includes a body 4 and one or more locking structures (e.g., fin 7, gusset 9, passage 11, platform 13, channel 15, and the like). The locking structures can be sized and shaped to interact with the subsequently poured material to inhibit movement of the mount 6 relative to the material in at least one direction (e.g., sideways, upward, downward, and/or rotation). In certain embodiments, the mount 6 prevents any significant movement of the mount 6 relative to the surrounding material (e.g., concrete). By preventing movement of the mount 6, once the outer housing 12 and an inner housing assembly 14 (see FIG. 4) are assembled so as to be secured relative to the mount 6 (directly or indirectly), undesirable movement of the inner housing assembly 14 is also prevented.

For example, in certain embodiments, the locking structures include one or more fins 7 forming channels 15 there between. In certain embodiments, the one or more fins 7 extend in an outward radial direction from the body 4. In the illustrated embodiment, the mount 6 comprises eight fins 7 and eight channels 15 equally spaced about the outer circumference of the body 4. Of course, the number, spacing, and geometry of the one or more fins 7 and the channels 15 are not limited to the illustrated embodiment. For example, the mount 6 can comprise more or less than the illustrated number of fins 7 (e.g., 2, 3, 4, 5, 6, 7, 9, 10, 11, 12, etc.) without deviating from the scope of this disclosure.

In certain embodiments, the one or more fins 7 need not be vertically aligned and instead can have any other alignment relative to the body 4. For example, in certain embodiments, the mount 6 comprises one or more vertical fins 7 and/or one or more horizontal fins 7. Further, each fin 7 need not extend in a single direction and can instead include a first portion that extends in a first direction and a second portion that extends in a second direction different than the first direction.

In the illustrated embodiment, the one or more fins 7 comprise a gusset 9 at an upper end. The gusset 9 transitions an outer profile of the fin 7 back towards a neck of the mount 6. In the illustrated embodiment, a lower end of the one or more fins 7 couples to a platform 13. The platform 13 couples the one or more fins 7 with a first end 74 (see FIG. 4) of the mount 6. In certain embodiments, the gussets 9 and the platform 13 provide additional structural support to ends of the one or more fins 7.

During installation, the concrete, dirt, clay, or other material flows into and fills the channels 15 formed between the one or more fins 7 resulting in an outer surface of the one more fins 7 to abut against the material. The contact between the one or more fins 7 and the material (once dried) prevents the mount 6 from rotating in the material. In certain embodiments, a top surface of the platform 13 abuts the material in the bottom of the channels 15 and prevents movement of the mount 6 relative to the material in at least an upward direction. In certain embodiments, the inclusion of a neck or other hourglass shape into the overall shape of the mount 6 further inhibits upward or downward motion of the mount 6 when the neck is surrounded by the material.

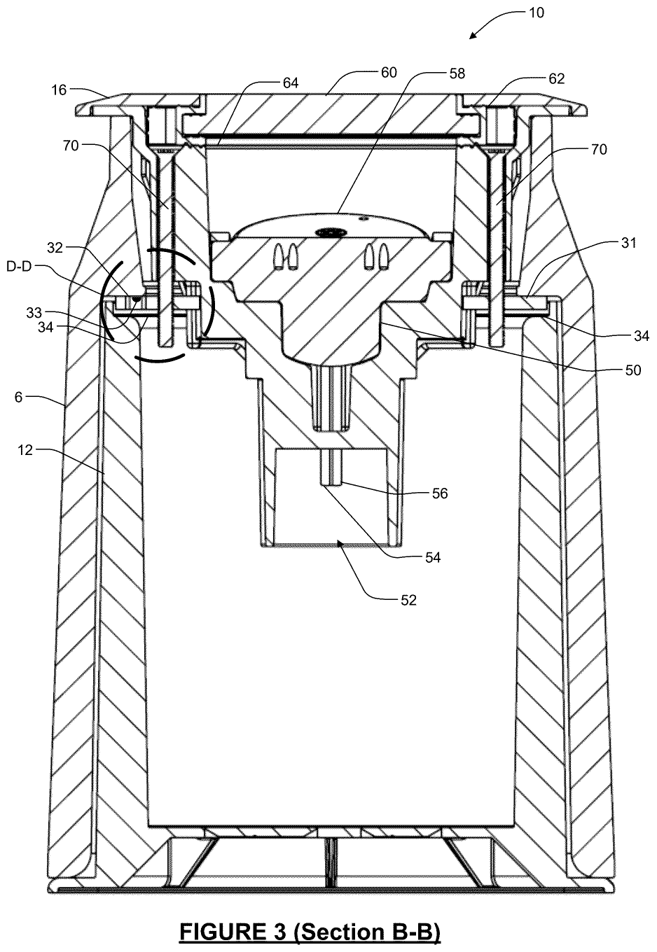

The light components which are part of an inner housing assembly 14 are installed within the outer housing 12 and the mount 6. In certain embodiments, one or more screws 70 engage between the inner housing assembly 14 and the mount 6 so as to secure the inner housing assembly 14 to the mount 6. By adjusting the screws 70 of the inner housing assembly 14, the user is able to create a desirable amount of compression between the inner housing assembly 14 and the mount 6. For example, the compression can lock the inner housing assembly 14 in the mount 6. As will be described below and illustrated in FIG. 3, in certain embodiments, the locking occurs between one or more holes or recesses 32 in a ring 31 and one or more teeth 33 projecting from the mount 6. Adjustment of the screws 70 causes the one or more teeth 33 to engage with the one or more holes or recesses 32 so as clamp the inner housing assembly 14 to the mount 6.

In the illustrated embodiment, the body 4 of the mount 6 has an annular shape. Of course, the shape of the body 4 is not limited to the illustrated shape and can have any other shape (e.g., square, elliptical, rectangular, etc.).

The mount 6 can be manufactured out of one or more materials (e.g., plastic, rubber, metal, etc.). In certain embodiments, the one or more materials are selected to provide an adequate level of friction (e.g., prevent relative movement once installed) when in contact with the outer housing 12 and/or surrounding material so as to further inhibit relative movement between the mount 6 and the outer housing 12 and/or material. For example, the mount 6 can be made from ABS or another high hardness material if the contact between the ABS and the material provides an adequate level of friction to further prevent relative movement (e.g., ABS and a very rough concrete). The amount of friction can be further adjusted by varying the size of the contact area between the mount 6 and the surrounding material.

In certain embodiments, the mount 6 is made from more than one material. For example, in certain embodiments, the body 4 of the mount 6 is manufactured out of ABS and the locking structures (e.g., fins 7) of the mount 6 which contact the surrounding material are manufactured from rubber or other high friction material to enhance their grip. In certain embodiments, the one or more fins 7 are over molded with the body 4 of the mount 6. In certain other embodiments, the one or more fins 7 are assembled to the body 4.

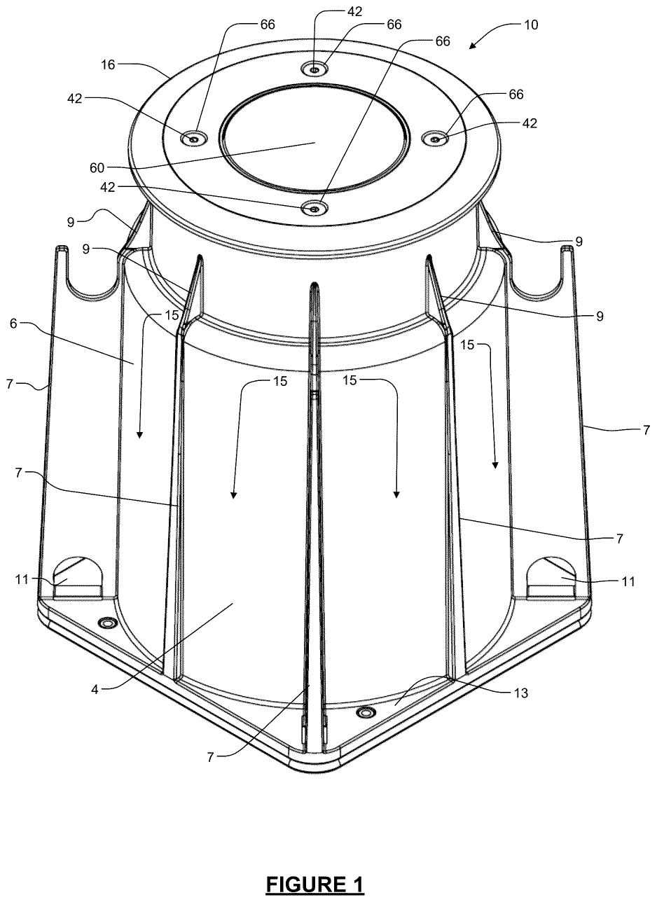

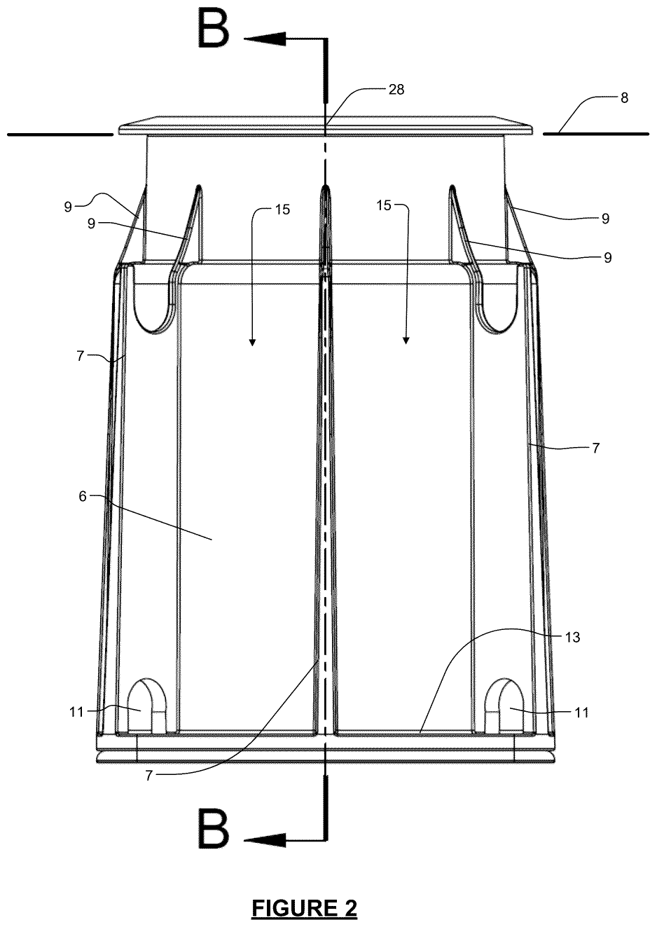

FIG. 1 is a perspective, top, side view of an in-grade light fixture or assembly 10 that includes a mount 6 configured to be disposed almost entirely below ground level 8. FIG. 2 is a side view of the in-grade light assembly 10 from FIG. 1. Because in-grade light assemblies 10 are often installed at least partially underground, they are especially susceptible to moisture, dirt, and other environmental hazards. In some cases, the position of the in-grade light assembly 10 can make replacement and/or repair of parts within the in-grade light assembly 10 difficult due to the high risk of moisture ingress into the in-grade light assembly 10 and the difficulty of removing moisture from the in-grade light assembly 10.

In some applications, activities such as lawn mowing, walking, driving, pressure-washing, and/or other activities can be performed on and/or near the in-grade light assembly 10 without negatively impacting the integrity or performance of the in-grade light assembly 10. For example, the mount 6 can be placed around an outer housing 12 of the in-grade light assembly 10 and include locking features (e.g., fins, gussets, etc.) which interact with its surrounding (e.g., concrete, dirt, clay, or other material) to prevent, for example, rotation of the mount 6 relative to the surrounding material even when experiencing loading caused in part by, for example, turning of a vehicle's tire when on the in-grade light assembly 10. Additionally, it can be difficult to readjust the direction (e.g., angle, tilt, etc.) of the light produced from the in-grade light assembly 10 after unintended rotation of the in-grade light assembly 10 occurs due to excessive rotational loading caused by turning of the vehicle's tire. Further, even if readjusted, future contact with another vehicle's tire can throw the light produced by the in-grade light assembly 10 back out of adjustment.

An example of such an in-grade light assembly 10 is illustrated in FIGS. 1 and 2. The in-grade light assembly 10 can include one or more housings in which electrical and mechanical components are housed. For example, the in-grade light assembly 10 can include the mount 6 and the outer housing 12. The inner housing assembly 14 may be positioned at least partially within the outer housing 12 when the in-grade light assembly 10 is assembled.

The inner housing assembly 14 can include a body 18 as illustrated in FIG. 4. In some embodiments, the body 18 can be configured to releasably connect to the mount 6 and/or the outer housing 12 via the one or more screws 70. For example, in the illustrated embodiment of FIG. 3, adjustment of the one or more screws 70 can fix and/or lock a position of the inner housing assembly 14 within the outer housing 12. In certain embodiments, a light module or cartridge 50 can be tilted relative to the body 18. The in-grade light assembly 10 can include a cover 16 configured to couple with one or both of the mount 6 and the inner housing assembly 14.

The body 18 can be manufactured out of one or more materials (e.g., plastic, rubber, metal, etc.). For example, in certain embodiments, the body 18 can be made from brass. In other embodiments, the body 18 is made from a composite plastic.

As will be discussed in more detail below, the mount 6 of the in-grade light assembly 10 can include one or more locking structures configured to facilitate fixing and/or locking the position of the mount 6 within the outer landscaping structure (e.g., concrete, dirt, clay, or other material).

The outer housing 12 of the in-grade light assembly 10 can include a sleeve portion 22. The sleeve portion 22 can have a first end (e.g., lower end) 24 and a second end (e.g., upper end) 26. The second end 26 can be open. In some embodiments, the first end 24 is closed. In certain embodiments, the outer housing 12 (e.g., the sleeve portion 22) is hollow or at least partially hollow. The outer housing 12 can have an axis 28 (see FIG. 2) extending through one or both of the first and second ends 24, 26 of the sleeve portion 22.

The sleeve portion 22 can be connected to a connection portion 30 (see FIG. 4). The connection portion 30 can be, for example, positioned at the second end 26 of the sleeve portion 22. The connection portion 30 can be configured to connect and/or support the mount 6.

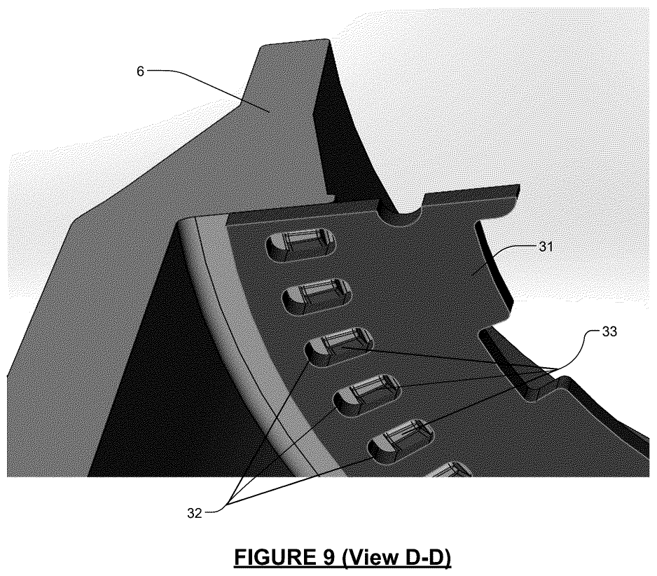

In certain embodiments, the connection portion 30 can comprise a ring 31. The ring 31 and/or the mount 6 can be manufactured out of one or more materials (e.g., plastic, rubber, metal, etc.) that provide an adequate level of friction (e.g., prevent relative movement once installed) when in contact with the mount 6 and/or ring 31. For example, the ring 31 can be made from a plastic if the contact between the plastic and the material of the mount 6 provides an adequate level of friction to prevent relative movement. In other embodiments, the ring 31 can be made from metal or another high hardness material if the contact between the metal of the ring 31 and the material of the mount 6 provides an adequate level of friction to prevent relative movement. The amount of friction can be further adjusted by, for example, varying the size of the contact area between the one or more teeth 33 (see FIG. 9) of the mount 6 and the perimeters of the one or more holes or recesses 32 of the ring 31.

In certain embodiments, the ring 31 is made from more than one material. For example, in certain embodiments, a core of the ring 31 is manufactured out of metal and the regions (e.g., lands between the one or more holes 32) of the ring 31 which contact the mount 6 are manufactured from silicone or other high friction material to enhance their grip.

In certain embodiments, the one or more teeth 33 are molded into the mount 6. In certain embodiments, the one or more teeth 33 are over molded with the mount 6. In certain other embodiments, the one or more teeth 33 are assembled to the mount 6.

In certain embodiments, the ring 31 comprises the one or more holes or recesses 32. The one or more holes 32 can be positioned so as to receive the one or more teeth 33 projecting from the mount 6. In the illustrated embodiment, the one or more teeth 33 project in a downward direction. When the one or more teeth 33 are engaged with the one or more holes 32, the inner housing assembly 14 is clamped to the mount 6 inhibiting or preventing at least relative rotation.

In certain embodiments, adjustment of the one or more screws 70 causes the one or more teeth 33 to engage with the one or more holes or recesses 32 so as clamp the inner housing assembly 14 to the mount 6. For example, in certain embodiments, external threads of the one or more screws 70 engage with internal threads of a retainer 34. The retainer 34 can be a nut or other fastening structure (e.g., annular ring) configured to engage with the one or more screws 70. In the embodiment illustrated in FIG. 3, the retainer 34 is disposed below the ring 31.

In certain other embodiments, the ring 31 itself comprises an internal thread configured to engage with the external thread of the one or more screws 70. In such an embodiment, the retainer 34 may not be required as the external threads of the one or screws 70 can engage with the internal threads of the ring 31. In embodiments that include the retainer 34, tightening of the one or more screws 70 compresses the retainer 34 against the ring 31 causing the one or more holes 32 in the ring 31 to engage with portions of the one or more teeth 33 projecting from the mount 6.

In certain embodiments, the one or more screws 70 initially pass through holes in the inner housing assembly 14, the ring 31, and the retainer 34. With the one or more screws 70 passing through the holes before the one or more holes 32 engage with the one or more teeth 33, the user can rotate the inner housing assembly 14 and the ring 31 (and the retainer 34 if present) until a desirable clocking of the beam is achieved. This rotation can occur before the one or more screws 70 are tightened. Once the desirable clocking is achieved, the one or more screws 70 are tightened so as to secure the inner housing assembly 14 to the mount 6. Once the one or more teeth 33 of the mount 6 are engaged with the one or more holes 32 of the ring 31 by turning the one or more screws 70, the inner housing assembly 14 is prevented from rotating relative to the mount 6. In some embodiments, the ring 31 can include one or more surface features (e.g., adhesive, protrusions, etc.) configured to increase a degree of the interference between the ring 31 and the mount 6.

By adjusting the one or more screws 70 of the inner housing assembly 14, the user is able to create a desirable amount of compression between the inner housing assembly 14 and the mount 6. For example, the compression can lock the inner housing assembly 14 in the mount 6. In certain embodiments, the locking occurs between the one or more holes 32 and the one or more teeth 33. Adjustment of the one or more screws 70 (e.g., clockwise or counterclockwise) causes the one or more teeth 33 to engage to or disengage from the one or more holes 32 so as clamp or loosen the inner housing assembly 14 relative to the mount 6.

In certain other embodiments, the one or more teeth 33 are disposed on the ring 31 and engage with one or more recesses (not shown) in a surface of the mount 6.

The sleeve portion 22 can have a cylindrical or generally cylindrical shape. In some embodiments, one or more segments of the sleeve portion 22 have a different shape from one or more other segments of the sleeve portion 22. For example, one or more segments of the sleeve portion 22 can have a rectangular cross-sectional shape (e.g., as measured perpendicular to the axis 28), a triangular cross-sectional shape, an oval cross-section, and/or some other polygonal or curved cross-sectional shape.

The outer housing 12 can include one or more electrical ports. For example, the outer housing 12 can include two electrical ports. Three or more electrical ports are also contemplated. The one or more electrical ports can be configured to facilitate electrical connection between the interior of the outer housing 12 and the exterior of the outer housing 12. In certain embodiments, the one or more electrical ports are positioned at or near the first end 24 of the sleeve portion 22.

In certain embodiments, the one or more electrical ports can be a stamped portion of the sleeve portion 22. The stamped portion can be punched out if or when the user (e.g., installation technician) decides to use the electrical port in question. Unused electrical ports can be left un-punched and impervious to fluid ingress or egress. In certain embodiments, the electrical ports may be molded into a bottom surface of the outer housing 12.

The electrical ports can include threaded portions configured to engage with electrical fittings. In some embodiments, the electrical ports are configured to engage with external electrical fittings in a fluid and/or liquid-tight manner.

The mount 6 of the in-grade light assembly 10 can include a sleeve portion 72. The sleeve portion 72 can have a first end (e.g., lower end) 74 and a second end (e.g., upper end) 76. The first and second ends 74, 76 can be open. In certain embodiments, the mount 6 (e.g., the sleeve portion 72) is hollow or at least partially hollow. The axis 28 can extend through one or both of the first and second ends 74, 76 of the sleeve portion 72.

The sleeve portion 72 can be connected to a connection portion 80 (see FIG. 4). The connection portion 80 can be, for example, positioned at the second end 76 of the sleeve portion 72. The connection portion 80 can be configured to connect and/or support the inner housing assembly 14.

The sleeve portion 72 can have a cylindrical or generally cylindrical shape that is configured to fit over the sleeve portion 22 of the outer housing 12. In some embodiments, one or more segments of the sleeve portion 72 have a different shape from one or more segments of the sleeve portion 22.

FIG. 3 is a cross-section view of the in-grade light assembly 10 of FIG. 2 taken along the cut-plane B-B. The inner housing assembly 14 can be configured to couple and decouple with the mount 6 and/or the outer housing 12. In some embodiments, the inner housing assembly 14 is configured to pass at least partially through the second end 76 of the mount 6 and the second end 26 of the outer housing 12 during coupling with and decoupling from the mount 6 and/or outer housing 12.

The inner housing assembly 14 can be constructed such that, when assembled, the inner housing assembly 14 hermetically (e.g., in an air-tight, or water-tight manner) seals an interior of the inner housing assembly 14 from an exterior of the inner housing assembly 14.

FIG. 4 is an exploded view of the in-grade light assembly 10 from FIG. 1 showing how the mount 6 is assembled to the outer housing 12. The inner housing assembly 14 (e.g., body 18) can include a mating structure 40. The mating structure 40 can be, for example, a shoulder, flange, indentation, protrusion, aperture, and/or some other structure configured to facilitate mating between the inner housing assembly 14 and the mount 6. In the illustrated embodiment, the mating structure 40 is a shoulder configured to be held (e.g., compresses, wedged, and/or secured) between the heads of one or more fastener 42 and the mount 6 when the one or more fasteners 42 are connected to the mount 6. In some embodiments, an intermediate structure such as a washer can be positioned between the heads of the fasteners 42 and the mating structure 40 to hold the mating structure 40. The fasteners 42 can be configured to mate with one or more outer apertures of the mount 6 (e.g., of the connection portion 80 of the mount 6).

The inner housing assembly 14 can include the body 18. In certain embodiments, the body 18 is hollow or at least partially hollow and is configured to receive the light module or cartridge 50.

The light module or cartridge 50 can be configured to removably connect to the body 18. The light module or cartridge 50 can include numerous structural features and components configured to house, maintain, or otherwise integrate with one or more electrical/lighting features and components. The light module or cartridge 50 can be configured to facilitate removal, repair, installation, and/or other customization of the lighting features connected to the light module or cartridge 50. For example, unlike standard “smart” light bulbs, the light module or cartridge 50 can be configured such that one or more light engines, controllers, plugs, sensors, and/or other components may be replaced and/or swapped with other components.

The electrical/lighting components can include a light unit assembly 58. The light unit assembly 58 can be configured to generate light and direct that light with desired lighting characteristics (e.g., shape, intensity, direction, color, and/or other characteristics) from the light module or cartridge 50. In some embodiments, the light module or cartridge 50 includes one or more electrical connections (e.g., plugs) configured to electronically connect with complementary electronic features of the in-grade light assembly 10.

The light unit assembly 58 can include a light engine configured to generate light. In some embodiments, the light unit assembly 58 includes a beam reflector and/or a beam director, each of which can be configured to alter the shape and/or intensity of the light generated by the light engine. The light engine can be or include a light emitting diode (LED) or an array of multiple LEDs. In some embodiments, the light engine is a light bulb (e.g., an incandescent, fluorescent, halogen, or other bulb type). In some embodiments, the light engine includes one or more circuit boards and/or other electrical components. The light engine can be electronically connected to one or more sources of power and/or to one or more control units. For example, the light engine can include a plug or other electrical connector configured to mate with the driver and/or with some other component of the light module or cartridge 50.

The light unit assembly 58 can include one or more optical components. The optical component(s) can be, for example, one or more of a diffuser, a color filter, secondary lens, and/or some other optical component.

In some embodiments, the light unit assembly 58 can include a beam director. The beam director can include one or more protrusions configured to at least partially shroud and reflect the light emitted from the light engine. Many other light-directing shapes, including ellipses, polygons, and combinations thereof, can be produced by beam directors with appropriate protrusion arrangements. The light module or cartridge 50 can be tilted or otherwise non-parallel to the body 18. Angular offset between the light module or cartridge 50 and the body 18 can permit direction of the light from the light module or cartridge 50 in a direction tilted from the axis 28.

As is illustrated in FIG. 4, embodiments of the in-grade light assembly 10 are secured within the outer housing 12 and the mount 6. The mount 6 is placed around the outer housing 12 and includes one or more of the locking features (e.g., fins, gussets, etc.). The locking features interact with their surroundings (e.g., concrete, dirt, clay, or other material) to prevent, for example, rotation of the mount 6 relative to the surrounding material even when experiencing loading caused in part by, for example, turning of a vehicle's tire when on the in-grade light assembly 10. For example, the in-grade light assembly 10 illustrated in FIG. 4 has a hollow shaped outer housing 12 which is fixedly installed almost entirely below ground level 8. The hollow-shaped mount 6 is installed over the outer housing 12.

In certain embodiments, the body 4 of the mount 6 includes the one or more locking structures (e.g., fin 7, gusset 9, passage 11, platform 13, channel 15, and the like). The locking structures can be sized and shaped to interact with the subsequently poured material to inhibit movement of the mount 6 relative to the material in at least one direction (e.g., sideways, upward, downward, and/or rotation). In certain embodiments, the mount 6 prevents any significant movement of the mount 6 relative to the material. By preventing movement of the mount 6, once the outer housing 12 and the inner housing assembly 14 are assembled so as to be secured relative to the mount 6 (directly or indirectly), undesirable movement of the inner housing assembly 14 is also prevented.

In the illustrated embodiment, the locking structures include the one or more channels 15 formed by the one or more fins 7. In the illustrated embodiment, the mount 6 comprises eight fins 7 and eight channels 15 equally spaced about the outer circumference of the body 4. Of course, the number, spacing, and geometry of the one or more fins 7 and the channels 15 are not limited to the illustrated embodiment. For example, the mount 6 can comprise more or less than the illustrated number of fins 7 (e.g., 2, 3, 4, 5, 6, 7, 9, 10, 11, 12, etc.) without deviating from the scope of this disclosure.

In certain embodiments, the one or more fins 7 need not be vertically aligned and instead can have any other alignment relative to the body 4. For example, in certain embodiments, the mount 6 comprises one or more vertical fins 7 and/or one or more horizontal fins 7. Further, each fin 7 need not extend in a single direction and can instead include a first portion that extends in a first direction and a second portion that extends in a second direction different than the first direction.

In the illustrated embodiment, each of the one or more fins 7 comprises a gusset 9 near the second end 76 of the mount 6. The gusset 9 transitions an outer profile of the fin 7 back towards a neck of the mount 6. In the illustrated embodiment, a lower end of the one or more fins 7 couple to the shared platform 13. The platform 13 couples the one or more fins 7 with the first end 74 of the mount 6. In certain embodiments, the gussets 9 and the platform 13 provide additional structural support to ends of the one or more fins 7.

During installation, the material (e.g., concrete, dirt, clay, or other material) can flow into and fill the channels 15 formed between the one or more fins 7 resulting in an outer surface of the one more fins 7 abutting or at least being in close proximity to the material. The abutment between the one or more fins 7 and the material prevents the mount 6 from, for example, rotating in the material. In certain embodiments, a top surface of the platform 13 abuts the material in the bottom of the channels 15 and prevents movement of the mount 6 relative to the surrounding material in at least an upward direction along the axis 28. In certain embodiments, the inclusion of a neck or other hourglass shape into the overall shape of the mount 6 further inhibits upward or downward motion along the axis 28 of the mount 6 when the neck is surrounded by the material.

In certain embodiments, as one or more screws 70 are tightened, the inner housing assembly 14 becomes secured to the mount 6 and/or outer housing 12. In certain embodiments, the one or more screws 70 lock or fix the position of the inner housing assembly 14 within the mount 6. In certain embodiments, the locking occurs between the one or more holes 32 in the ring 31 and the one or more teeth 33 projecting from the mount 6. Adjustment of the screws 70 causes the one or more teeth 33 to engage with the one or more holes 32 so as clamp the inner housing assembly 14 to the mount 6.

The inner housing assembly 14 can include a tilting assembly 52. The tilting assembly 52 can extend downward from the body 18. The tilting assembly 52 can be configured to facilitate user control over the tilt angle of the light module or cartridge 50 with respect to the body 18. The tilting assembly 52 can include one or more user input portions configured to receive user input. The tilting assembly 52 can include one or more components configured to translate the user input to tilt the light module or cartridge 50 in one or more directions. In certain embodiments, the tilting assembly 52 can include an adjusting shaft 54. The adjusting shaft 54 can include a user input portion 56 accessible from a first end of the shaft 54. In certain embodiments, the user can lock the tilt angle of the light module or cartridge 50 once a desirable tilt angle is achieved.

Once inserted into the sleeve portion 72 and resting on the second end 76 of the mount 6, the one or more screws 70 can be tightened causing the one or more teeth 33 to lock within the one or more holes 32. Removal of the one or more screws 70 allows the inner housing assembly 14 to be removed from the mount 6.

In some cases, all or a portion of the inner housing assembly 14 can be disassembled while positioned in the mount 6.

A lens 60 can be installed on the body 18 to seal an interior of the inner housing assembly 14. For example, the lens 60 can be installed on the inner housing assembly 14 using fasteners, detents, friction fittings, or other releasable connection methods or structures.

In some embodiments, the inner housing assembly 14 includes a lens seal or gasket 62. The lens seal 62 can have an annular shape and can be sized to engage with a portion of the body 18. For example, the lens seal 62 can be configured to engage with a seal groove 64 of the body 18.

The cover 16 can be configured to connect to the body 18, the mount 6, and/or the outer housing 12. For example, the cover 16 can include one or more apertures 66 (see FIG. 1) configured to receive the fasteners 42. The one or more apertures 66 can be distributed to align with one or more inner apertures in the body 18. One or more fasteners 42 can be inserted through the apertures 66 of the cover 16 and the body 18 and then tightened to compress the gasket 62 between the lens 60 and the body 18.

In some embodiments, the gasket 62 includes one or more gaps or spaces in its perimeter. The spaces can be sized and/or positioned to facilitate user access to the one or more screws 70. In certain embodiments, installation of the cover 16 prevents access to the one or more screws 70. Removal of the cover 16 allows the user to access the one or more screws 70 so as to create, remove, or adjust the compression between the mount 6/outer housing 12 and the inner housing assembly 14.

To remove the inner housing assembly 14 from the mount 6, the user may disconnect the one or more fasteners 42 from the mount 6 to access the one or more screws 70. Removing the one or more screws 70 allows the user to lift the inner housing assembly 14 from the mount 6.

In some embodiments, one or more electrical connections (e.g., plugs or other connections) between the inner housing assembly 14 and some other portion of the in-grade light assembly 10 can be disconnected to completely remove the inner housing assembly 14 from the in-grade light assembly 10.

To adjust the tilt of the light module or cartridge 50, a user can remove the cover 16. Once removed, the user can rotate the light module or cartridge 50 within the body 18 (e.g., about an axis or rotation parallel or substantially parallel to the axis 28) by hand or by use of a tool. Upon loosening or removing of the one or more fasteners 42, the user can then rotate the light module or cartridge 50 to different desired rotational position. In certain embodiments, the user can lock the tilt angle of the light module or cartridge 50 once a desirable tilt angle is achieved.

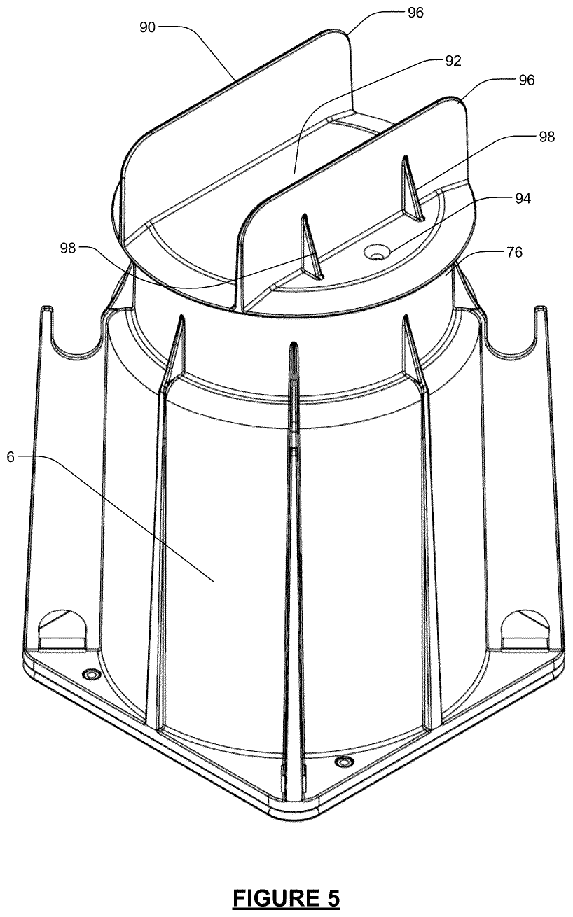

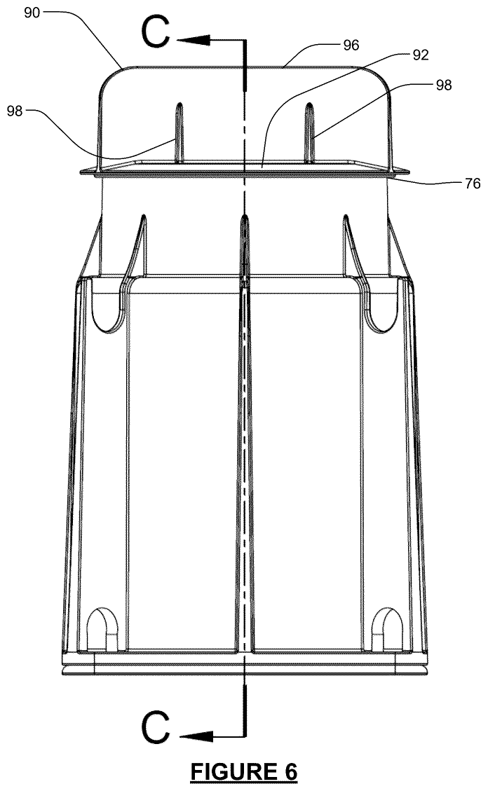

FIG. 5 is a perspective view of the in-grade light assembly 10 from FIG. 1 with the inner housing assembly 14 temporarily replaced with an installation cap 90. FIG. 6 is a side view of the in-grade light assembly 10 and the installation cap 90 from FIG. 5. In some applications, the outer housing 12 and the mount 6 may first be installed before other components of the in-grade light assembly 10 are assembled. For example, in a landscaping or walkway application, it may be desirable to install the outer housing 12 and the mount 6 in the ground before assembling the remaining in-grade light components. Installing the outer housing 12 and the mount 6 in concrete or other materials may present challenges, as it may be difficult to properly chair (e.g., align) the upper end of the mount 6 with the ground level 8 of the walkway or other installation site.

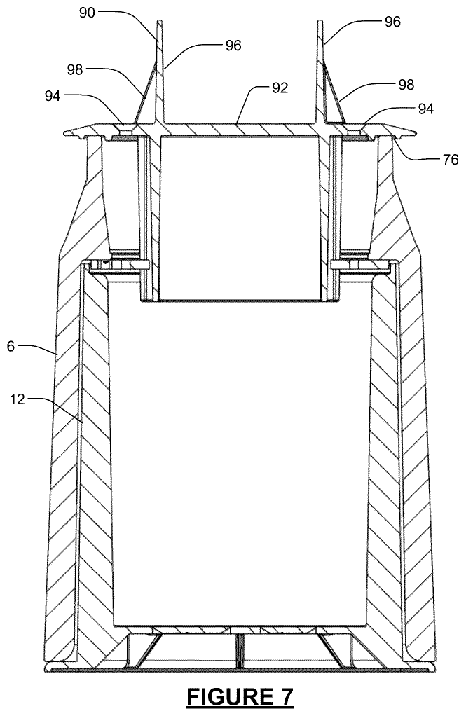

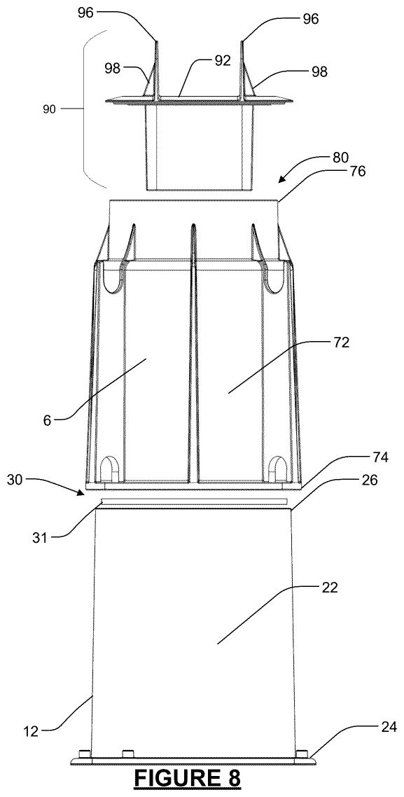

FIG. 7 is a cross-section view of the in-grade light assembly 10 of FIG. 6 taken along the cut-plane C-C. FIG. 8 is an exploded view of the in-grade light assembly 10 from FIG. 4 showing how the installation cap 90 is assembled to the mount 6. As illustrated, the installation structures can include the installation cap 90. The installation cap 90 can include a cover portion 92 having a generally planar shape. In some embodiments, the cover portion 92 is sized to cover all or substantially all of the upper end 76 or connection portion 80 of the mount 6. The cover portion 92 can include one or more apertures 94 configured to align with the apertures of the mount 6. The one more fasteners 42 can be inserted through the apertures 94 into the apertures of the mount 6 to connect the installation cap 90 to the mount 6. In some embodiments, other connection methods and structures (e.g., detents, friction fittings, threading, etc.) are used in addition to or instead of the one or more fasteners 42.

The installation cap 90 can include one or more upward walls 96 extending from the cover portion 92. The upward walls 96 can be structurally supported by one or more ribs 98 extending between the upward walls 96 and the cover portion 92. The upward walls 96 can include one or more apertures configured to facilitate connection of the upward walls 96 to a chairing structure (e.g., a wood beam).

An exemplary chairing structure can be braced and/or supported by one or more supports (e.g., blocks, beams, or other structures). The mount 6 can be suspended in the installation site using the installation cap 90 and supports. Concrete, dirt, clay, or other materials can be filled in around the mount 6 to reduce the likelihood that the upper end of the in-grade light assembly 10 is misaligned with the surface of the finished walkway or other installation feature. Upon pouring and/or setting of the concrete/dirt, the installation cap 90 can be removed and the other components of the in-grade light assembly 10 can be installed. In some cases, the cover portion 92 may have a width greater than the diameter of the mount 6. In some embodiments, an outer width or diameter of the cover portion 92 is slightly larger than the outer diameter of the cover 16 to facilitate flush installation of the cover 16 with the surface of the concrete or other material surrounding the mount 6.

In some embodiments, wires and/or other electrical connection structures can be connected to the mount 6 prior to pouring of the concrete/dirt.

For expository purposes, the term “horizontal” as used herein is defined as a plane parallel to the plane or surface of the floor of the area in which the system being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

The terms “approximately”, “about”, “generally” and “substantially” as used herein represent an amount close to the stated amount that still performs a desired function or achieves a desired result. For example, the terms “approximately”, “about”, “generally,” and “substantially” may refer to an amount that is within less than 10% of the stated amount.

What is claimed is:

1. An in-grade light assembly for installation in a surrounding material, comprising:
a mount having:
a first end configured to be positioned at or below a planned ground level of the surrounding material;
a second end opposite the first end; and
a sleeve portion between the first end and the second end, the sleeve portion having one or more locking structures sized and shaped to direct flow of the surrounding material as the surrounding material is poured around the mount;
an outer housing sized and shaped to fit within the mount; and
an inner housing assembly sized and shaped to fit at least partially within the mount and the outer housing.

2. The in-grade light assembly of claim 1, wherein the surrounding material is concrete.

3. The in-grade light assembly of claim 1, wherein the one or more locking structures are a fin, a gusset, a passage, a platform, and/or a channel.

4. The in-grade light assembly of claim 1, wherein the one or more locking structures are configured to abut the surrounding material so as to inhibit at least rotation of the mount relative to the surrounding material.

5. The in-grade light assembly of claim 1, further comprising one or more screws configured to secure the inner housing assembly to the mount.

6. The in-grade light assembly of claim 5, further comprising a cover configured to prevent access to the one or more screws when the cover is secured to the inner housing assembly.

7. The in-grade light assembly of claim 1, wherein the inner housing assembly comprises a light module, the light module being configured to emit light through the first end of the mount when the inner housing assembly is installed within the mount.

8. The in-grade light assembly of claim 1, wherein the inner housing assembly comprises a lens assembly.

9. The in-grade light assembly of claim 8, wherein the lens assembly comprises at least one fastener aperture configured to align with at least one fastener aperture if the inner housing assembly.

10. A mount for use with an in-grade light assembly, the mount being configured for installation by pouring a material around the mount after the mount is positioned at or below a planned ground level of the material, comprising:
a first end configured to be positioned at or below the planned ground level of the material;
a second end opposite the first end; and
a sleeve portion between the first end and the second end, the sleeve portion having one or more locking structures sized and shaped to extend into the material so as to inhibit at least rotation of the mount relative to the material.

11. The mount of claim 10, wherein the mount has a hollow-shape.

12. The mount of claim 11, wherein the hollow-shape of the mount is sized to receive an outer housing.

13. The mount of claim 10, wherein the one or more locking structures is a fin, a gusset, a passage, a platform, and/or a channel.

14. The mount of claim 10, wherein the material is concrete.

15. The mount of claim 10, wherein the material is dirt or clay.

16. The mount of claim 10, wherein the one or more locking structures are configured to abut the material so as to inhibit at least rotation of the mount relative to the material.

17. An in-grade light assembly for installation in a surrounding material, comprising:
a mount having:
a first end configured to be positioned at or below a planned ground level of the surrounding material;
a second end opposite the first end; and
a sleeve portion between the first end and the second end;
an outer housing sized and shaped to fit within the mount;
an inner housing assembly sized and shaped to fit at least partially within the mount and the outer housing; and
a ring being disposed so as to contact at least a portion of the mount and prevent relative rotation of the inner housing assembly relative to the mount.

18. The in-grade light assembly of claim 17, wherein the portion of the mount comprises a first engagement structure, and wherein the ring comprises a second engagement structure, the second engagement structure contacting the first engagement structure to prevent the relative rotation of the inner housing assembly relative to the mount.

19. The in-grade light assembly of claim 18, wherein the first engagement structure is one or more teeth, and wherein the second engagement structure is one or more holes or recesses.

20. The in-grade light assembly of claim 18, further comprising one or more screws, wherein rotation of the one or more screws causes the one or more teeth to engage with the one or more holes or recesses.
